(19) United States
(12) Patent Application Publication
(10) Pub. No.: US 2005/0028010 A1
(43) Pub. Date: Feb. 3, 2005

(54) System and method for addressing denial of service virus attacks

(75) Inventor: Bruce Wallman, Princeton, NJ (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/629,170

(22) Filed: Jul. 29, 2003

(51) Int. Cl. H04L 9/00

(52) U.S. Cl. 713/201

(57) ABSTRACT

A system and method for addressing denial of service attacks directed at a web resource. The method comprises the steps of: receiving messages at the web resource; analyzing each message and determining if the message is improper; storing the source address of a message if the message is improper; responding to a first improper message from an identified source address with an HTTP error response; responding to a few subsequent improper messages from the identified source address with HTTP “OK” response codes; and finally stopping all responses to the identified source address.

### BACKGROUND OF THE INVENTION

1. Technical Field

The present invention relates generally to anti-virus systems, and more specifically relates to a system and method of addressing denial of service virus attacks aimed at web servers.

2. Related Art

Viruses or attacks are prevalent today throughout the Internet. One such type is referred to as a “denial of service” (DoS) attack in which a large number of requests are addressed to a particular shared web resource, e.g., by a “hacker” or “cracker.” Because any web resource has a fixed ability to respond to requests, a large volume of bogus requests will cause delays in servicing genuine requests. In a worst-case scenario, the resource may actually crash, completely denying service to legitimate requests. In a case where the web resource is a web server utilized by a business entity, a DoS attack can shut down services critical to the business entity.

Numerous systems have been proposed to address denial of service attacks. However, most such solutions often consume a significant amount of computational server resources to identify and process bogus requests, and/or require additional systems or resources to address the problem. For instance, U.S. Patent Application Publication US 2002/0002686 A1 by Vange et al., “Method and System for Overcoming Denial Of Service Attacks,” published on Jan. 3, 2002, requires a request processing component that receives requests on behalf of the web resource. Similarly, in U.S. Patent Application Publication US 2003/0023733 A1 by Lingafelt et al., “Apparatus and Method for Using a Network Processor to Guard Against a “Denial of Service” Attack on a Server or Server Cluster,” published on Jan. 30, 2003, requires a network processor interposed between the server and the network. The aforementioned publications are hereby incorporated by reference.

Thus, current solutions add significant additional computational requirements and costs to identifying and processing DoS attacks. Accordingly, a need exists for a system that can address DoS attacks at web resources, such as web servers, without adding significant costs and/or computational requirements.

### SUMMARY OF THE INVENTION

The present invention addresses the above-mentioned problems, as well as others, by providing a system and method for addressing denial of service attacks without adding significant computational requirements and costs. In a first aspect, the invention provides a system for addressing denial of service attacks directed at a web resource, comprising: a system for detecting improper requests; and a system for responding to improper requests that issues an HTTP “OK” response code when improper request is detected.

In a second aspect, the invention provides a method for addressing denial of service attacks directed at a web resource, comprising: receiving messages at the web resource; analyzing each message and determining if the message is improper; storing the source address of a message if the message is improper; responding to a first improper message from an identified source address with an HTTP error response; responding to a set of subsequent improper messages from the identified source address with HTTP “OK” response codes; and stopping responses to the identified source address for all received improper messages after the set of subsequent improper messages have been responded to.

In a third aspect, the invention provides a program product stored on a recordable medium for addressing denial of service attacks directed at a web resource, comprising: means for receiving messages at the web resource; means for analyzing each message and determining if the message is improper; means for storing the source address of a message if the message is improper; means for responding to a first improper message from an identified source address with an HTTP error response; means for responding to subsequent improper messages from the identified source address with HTTP “OK” responses.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a web server having a denial of service defense system in accordance with the present invention.

FIG. 2 depicts a flow diagram of a method of implementing a denial of service defense system in accordance with the present invention.

### DETAILED DESCRIPTION OF THE INVENTION

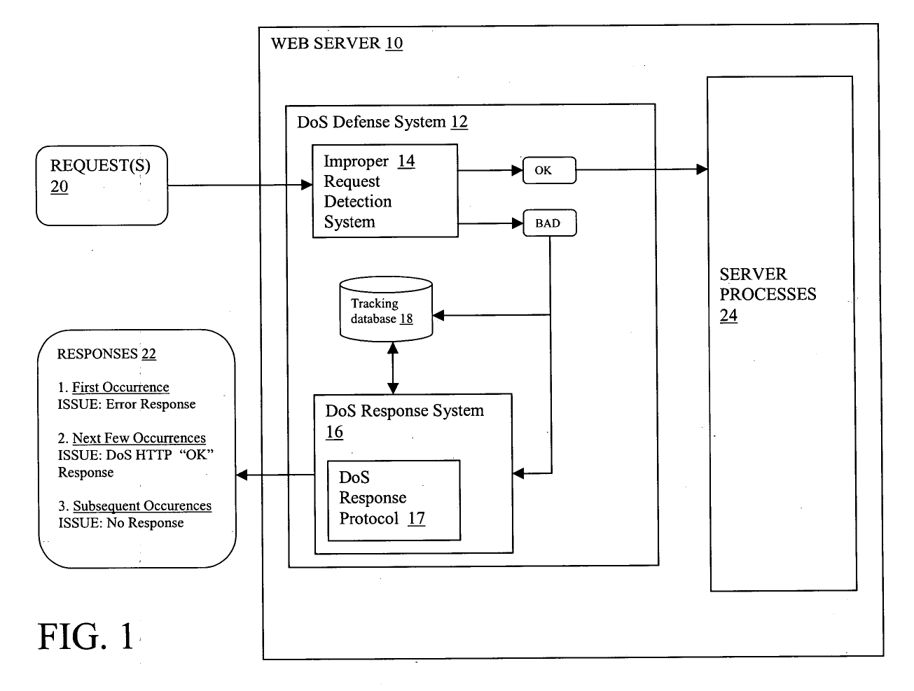

Referring now to the drawings, FIG. 1 depicts a web server 10 having a denial of service (DoS) defense system 12 for addressing DoS attacks. As explained in further detail below, DoS defense system 12 provides a relatively passive mechanism for handling messages associated with DoS attacks so that the resources consumed by the web server 10 will be less than those consumed by the attacker. Accordingly, the defensive behavior implemented by DoS defense system 12 will cause the attacker to stop the attack because of the attacker's resource consumption level.

DoS defense system 12 may be implemented as a standalone system, as a software program product, or be integrated into web server 10. In such implementations, DoS defense system 12 can be configured to act as a “front-end” to most of the server processes 14 that handle requests 20 sent to the web server 10. Thus, if an attack occurs, most server processes 14 of web server 10 will not affected or utilized. It should be understood that while the present invention is described with reference to a web server 10 that receives and responds to requests, the invention could be implemented with any web resource that receives and responds to any type of message using a hypertext transfer protocol (HTTP), or similar communications protocol.

DoS defense system 12 includes an improper request detection system 14, a tracking database 18, and a DoS response system 16 that includes a DoS response protocol 17. Improper request detection system 14 can include any logic that examines incoming requests 20 and determines if the request 20 appears to be improper. In the case of a typical application server known in the art, identifying improper requests is a relatively simple operation since the source and format of requests 20 are generally limited and known. For instance, a request may be deemed improper if: (1) it is received from an unexpected host, such as www; (2) if the received packet has a zero length; (3) if the received packet is neither an HTTP “post” or “get” command when only these commands are expected; or (4) if the request comprises “post” or “get” arguments unknown to the web server 10. In the event the request is deemed proper or good, it is passed to the standard set of server processes 14 for processing. Alternatively, if the request appears to be improper of bad, the request is passed to DoS response system 16. Furthermore, source information from all improper requests are stored in memory and/or a tracking database 18 so that improper requests from the same source can be identified and dealt with as an apparent DoS attack.

DoS response system 16 generates a sequence of responses 22 to the improper requests 20 based on DoS response protocol 17. In general, DoS response protocol 17 will cause HTTP 204 “OK” responses 22 (or other similar status codes) to be issued when an improper request is received. As is readily known in the art, HTTP includes a set of response codes that are used by a web server to provide a status back to the requesting resource. The codes may indicate success, redirection or error conditions. For instance, in HTTP/1.0, 200 means “OK; the request was fulfilled,” 204 means “OK, no response—request received but no info exists to send back,” etc. By responding to improper messages with an HTTP “OK” code 22, any attacker sending a message to purposefully slow the processing in web server 10 is hit with acceptances that look like their job is done. The attacker is then faced with either continuing to send the same message and receiving the same trivial response, or moving on. Typically, the attacker will retry some number of times, and then move on. Meanwhile, because the response is so trivial, the server continues to handle legitimate incoming messages without interruption.

If the attacker continues through a few “OK” responses, then the DoS response system 16 can be implemented to simply stop responding to the current stream of requests from the same source address. The attacker is forced to conclude that the attack was successful. However, even if the attacker continues to send improper requests, the attack will not disable the server since the effort to send out “no response” is so low that the server continues to handle legitimate messages without interruption.

In order to differentiate legitimate request errors from a DoS attack, various DoS response protocols 17 may be implemented. For instance, FIG. 1 depicts a response sequence 22 in which the first time an improper message is received from an IP address, a standard error message may be issued, e.g., an HTTP 404 “Not Found” message or an HTTP 400 “Bad Request” message. Then, for a subsequent set of improper messages from the same (or related) IP address, HTTP 204 “OK” messages may be issued. Obviously, the size of the subsequent “set” can be any number deemed appropriate to most effectively ward off the attack, such as 4-10 improper messages. Finally, if additional improper messages from the source are still received after the subsequent set, then “no response” will be issued. Different escalation schemes may be implemented depending on the nature and type of the improper request. For instance, DoS Repsonse System 16 may simply issue HTTP “OK” responses to all improper requests. Regardless of the-specific protocol, responding in this manner consumes very little computational resources. Thus, an important result is that improper messages are quickly identified and responded to in a standard, repeated manner with the goal of using less effort than the offending resource used to start and/or maintain the attack.

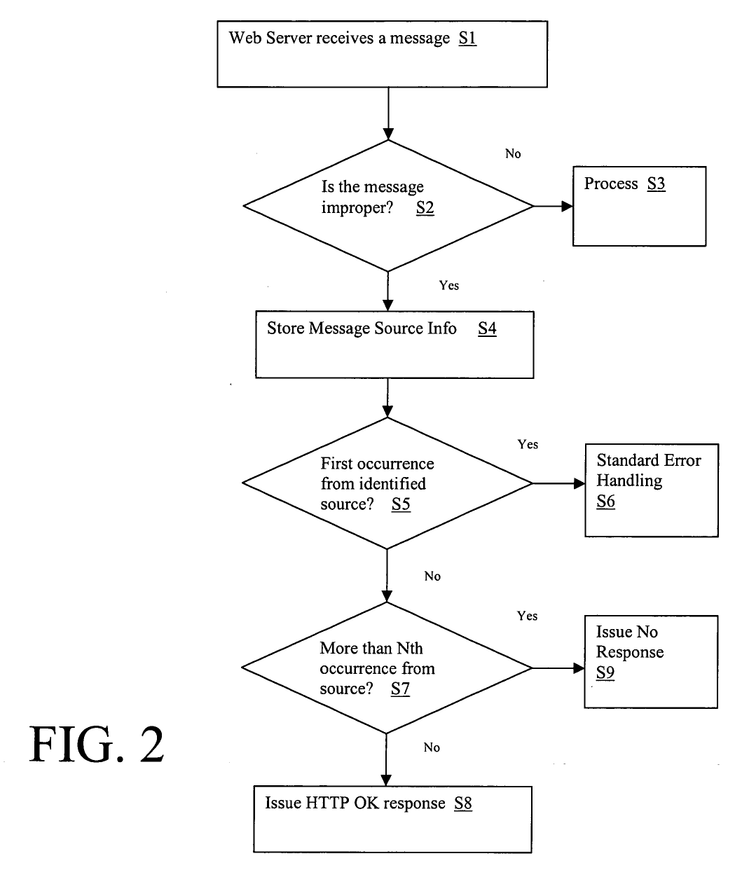

Referring now to FIG. 2, a flow diagram is shown depicting an exemplary methodology for implementing the DoS defense system 12. In the first step S1, the web server receives a message. At step S2, a determination is made whether the message is improper. If it is not improper, the message is processed at step S3 in a standard manner. If the message is deemed improper, information from the message, e.g., the source or Internet protocol (IP) address of the message is stored and tracked at step S4. Next, a determination is made whether the improper message is a first occurrence from the same source (e.g., based on the IP address or related IP addresses) at step S5. If the improper message is a first occurrence from the identified source of the message, then a standard error message or error handling procedure may be implemented at step S6. Alternatively, if the improper message is not a first occurrence from the identified source, then a check is made at step S7 to determine if more than N occurrences of the improper message (where N equals a predetermined number) have been received. If more than N occurrences have not been received, then an HTTP OK response is issued at step S8. If more than N occurrences have been received, then no response is issued at step S9.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for addressing denial of service attacks directed at a web resource, comprising:
a system for detecting improper requests; and
a system for responding to improper requests that issues an HTTP “OK” response code when improper request is detected.

2. The system of claim 1, wherein the system for responding stops issuing HTTP “OK” response codes and issues no response after a predetermined number of improper requests are detected.

3. The system of claim 1, wherein a request is deemed improper if the request is received from an unexpected host.

4. The system of claim 1, wherein a request is deemed improper if the request has a zero length.

5. The system of claim 1, wherein a request is deemed improper if an HTTP “post” or an HTTP “get” command is expected and neither an HTTP “post” nor an HTTP “get” command is received.

6. The system of claim 1, wherein a request is deemed improper if the request includes a HTTP “post” or “get” command with unknown arguments.

7. The system of claim 1, wherein the HTTP “OK” response code comprises an HTTP 204 “OK” message code.

8. The system of claim 1, wherein the system for responding to improper requests includes a response protocol that utilizes a standard error handling procedure for a first improper request from a requesting resource, issues an HTTP OK response code for N subsequent improper requests from the requesting resource, and then stops responding to the requesting resource altogether.

9. The system of claim 1, wherein the web resource comprises a server.

10. A method for addressing denial of service attacks directed at a web resource, comprising:
receiving messages at the web resource;
analyzing each message and determining if the message is improper;
storing the source address of a message if the message is improper;
responding to a first improper message from an identified source address with an HTTP error response;
responding to a set of subsequent improper messages from the identified source address with HTTP “OK” response codes; and
stopping responses to the identified source address for all received improper messages after the set of subsequent improper messages have been responded to.

11. The method of claim 10, wherein a message is deemed improper if the message is received from an unexpected host.

12. The method of claim 10, wherein a message is deemed improper if the message has a zero length.

13. The method of claim 10, wherein a message is deemed improper if the message is neither an HTTP “post” nor an HTTP “get” command when one of these commands is expected.

14. The method of claim 10, wherein a message is deemed improper if the message includes a HTTP “post” or “get” command with unknown arguments.

15. The method of claim 10, wherein the HTTP “OK” response code comprises an HTTP 204 “OK” message code.

16. The method of claim 10, wherein the HTTP “OK” response comprises an HTTP 200 “OK” message code.

17. A program product stored on a recordable medium for addressing denial of service attacks directed at a web resource, comprising:
means for receiving messages at the web resource;
means for analyzing each message and determining if the message is improper;
means for storing the source address of a message if the message is improper;
means for responding to a first improper message from an identified source address with an HTTP error response; and
means for responding to subsequent improper messages from the identified source address with HTTP “OK” response codes.

18. The program product of claim 17, further comprising means for stopping responses to the identified source address after a predetermined number of subsequent improper messages have been received.

19. The program product of claim 17, wherein a message is deemed improper if the message is received from an unexpected host; if the message has a zero length; if the message is neither an expected HTTP “post” nor an expected HTTP “get” command; or if the message includes a HTTP “post” or “get” command with unknown arguments.

20. The program product of claim 17, wherein the HTTP “OK” response codes comprise HTTP 204 “OK” response codes.

21. The program product of claim 17, wherein messages that are deemed proper are passed to the web resource for further processing.

22. The program product of claim 17, wherein the web resource is a web server.
